(19) United States
(12) Patent Application Publication
(10) Pub. No.: US 2009/0179417 A1
(43) Pub. Date: Jul. 16, 2009

(54) SYSTEM AND METHOD FOR CHILD AND PARENT IDENTIFICATION AND DISPLAYING MISSING CHILDREN

(76) Inventor: Miguel Papdopulos Murra, Torreon (MX)

Correspondence Address: BAKER & HOSTETLER LLP, WASHINGTON SQUARE, SUITE 1100, 1050 CONNECTICUT AVE. N.W., WASHINGTON, DC, 20036-5304, US

(21) Appl. No.: 12/014,366

(22) Filed: Jan. 15, 2008

(51) Int. Cl. B42D 15/10

(52) U.S. Cl. 283/77

(57) ABSTRACT

A set of identification cards are provided. The set of identification cards includes a first child identification card that itself includes personal information about a first child and a parent of the first child. The set of identification cards also includes a parent identification card that includes personal information about the parent and the first child.

### FIELD OF THE INVENTION

The present invention relates generally to systems and methods useful in identifying children and their parents. More particularly, the present invention relates to systems and methods useful in accurately and efficiently providing authorities with information about children and their parents and/or guardians.

### BACKGROUND OF THE INVENTION

Sadly, children throughout the world are subject to kidnappings, human trafficking and even worse fates. In Mexico alone, in 2006, there were approximately 50,000 missing children. Frequently, the kidnappings, etc., involve the crossing of national and/or international borders. These borders are also sometimes crossed using commercial carriers (e.g., airlines, railways, passenger ships and bus lines).

The above notwithstanding, throughout the world, most parents do not carry documents on their persons at all times that certify that they are indeed the parents of their children. Rather, parents typically only possess the birth certificates of their children, and these birth certificates are stored at remote locations (e.g., in a file cabinet at home or in a safe deposit box at a bank). As such, law enforcement officers are typically unable to quickly ascertain whether an adult traveling with a child is indeed doing so legally. Hence, the above-mentioned kidnappings and human trafficking are relatively difficult to detect and prevent.

The above-mentioned shortcomings of current child identification systems are exasperated by the fact that many countries do not issue civil identification cards whatsoever. Rather, many countries only issue passports and drivers' licenses. Since children are not allowed to drive until their mid- or late teen years, they are not eligible for drivers' licenses. Hence, at best, children are only eligible for passports. However, the vast majority of children in the world do not travel internationally. Also, passports are typically relatively expensive to obtain. As such, the vast majority of the world's children do not own a passport or any other kind of individual identification, and parents do not have or carry any portable identification that certifies them as parents.

In a very small number of more sophisticated and/or affluent regions, a few schools do provide iron-on identification patches that parents may adhere upon the clothes of their children. However, these patches are not applied to all of the child's clothing and are only distributed to a very small number of children. Further, there are no associated parent identification patches or any other form of parent identification supplied by the schools.

### SUMMARY OF THE INVENTION

The foregoing needs are met, to a great extent, by certain embodiments of the present invention. For example, according to one embodiment of the present invention, a set of identification cards is provided. The set of identification cards includes a child identification card that itself includes personal information about a child and one or both parents of the child, or of a guardian, if applicable. The set of identification cards also includes a parent identification card that includes personal information about the parent and one or more children.

According to another embodiment of the present invention, a child identification system is provided. The system includes a first module where information is submitted to generate a child identification card that includes personal information about a child and at least one parent of the child and one or more parent identification cards (typically one per parent) that includes personal information about a parent and one or more children. The system also includes a second module wherein the information submitted is stored. The system further includes a third module which sometimes serves as a checkpoint, wherein the child identification card and the parent identification card may be compared to confirm that an adult accompanying the child is the parent and is authorized to travel with the child. The system further sometimes includes a fourth module where a parent can report an emergency (e.g., the disappearance or kidnapping of one or more of the parent's children).

According to yet another embodiment of the present invention, a child identification procedure is provided. The procedure includes obtaining information about a parent and a child at a first location. The procedure also includes generating a child identification card that includes personal information about the child and the parent of the child. The procedure further includes generating a parent identification card that includes personal information about the parent and the child.

There has thus been outlined, rather broadly, an embodiment of the invention in order that the detailed description thereof herein may be better understood, and in order that the present contribution to the art may be better appreciated. There are, of course, additional embodiments of the invention that will be described below and which will form the subject matter of the claims appended hereto.

In this respect, before explaining at least one embodiment of the invention in detail, it is to be understood that the invention is not limited in its application to the details of construction and to the arrangements of the components set forth in the following description or illustrated in the drawings. The invention is capable of embodiments in addition to those described and of being practiced and carried out in various ways. Also, it is to be understood that the phraseology and terminology employed herein, as well as the abstract, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the present invention.

### BRIEF DESCRIPTION OF THE DRAWINGS

FIG. 1 illustrates the front and back sides of a child identification card and of a parent identification card according to an embodiment of the present invention.

FIG. 2 illustrates a child identification system according to an embodiment of the present invention for use in conjunction with the identification cards illustrated in FIG. 1.

FIG. 3 illustrates additional components of the child identification system illustrated in FIG. 2.

FIG. 4 is a table that lists information contained on representative ID cards according to certain embodiments of the present invention.

FIG. 5 illustrates a flowchart of a process for entering, storing and using child and parent information according to an embodiment of the present invention.

FIG. 6 illustrates a missing child report overlain onto a map.

### DETAILED DESCRIPTION

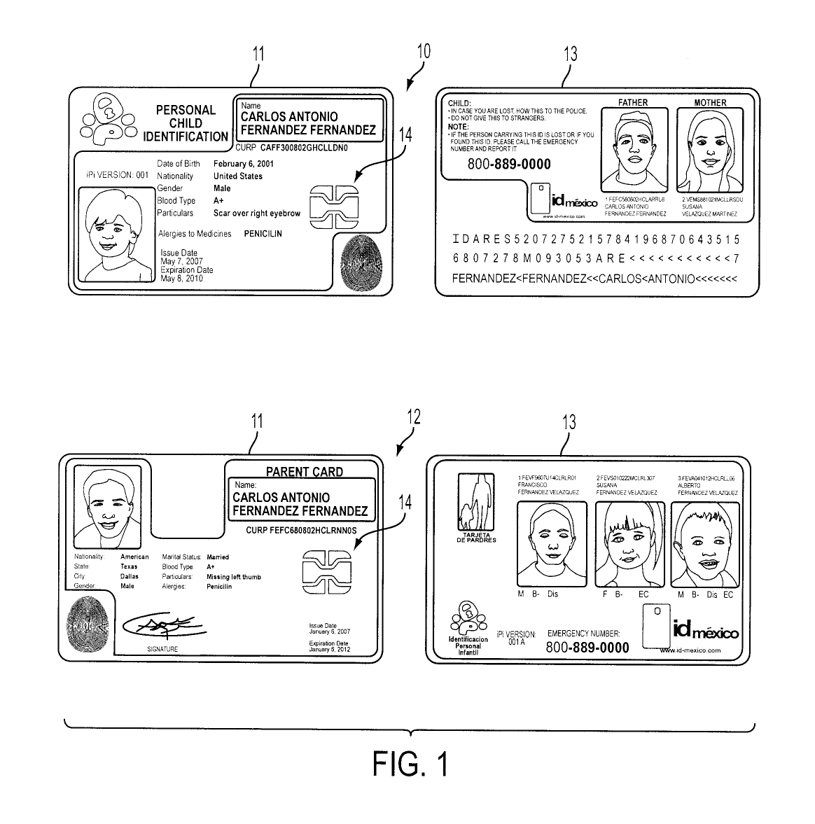

The invention will now be described with reference to the drawing figures, in which like reference numerals refer to like parts throughout. FIG. 1 illustrates the front sides 11 and back sides 13 of a child identification card 10 and of a parent identification card 12 according to an embodiment of the present invention. According to certain embodiments of the present invention, a system is provided wherein the child identification card 10 is issued to one or more children in a family and the parent identification card 12 is issued to each parent/guardian in the family. Depending on the embodiment of the present invention, any number or all of the child identification cards 10 and parent identification cards 12 include biometric information therein.

Many different types of biometric information may be used according to embodiments of the present invention. For example, fingerprint data may be used, as may data related to a person's eyes (e.g., iris), veins in their hands or fingers, etc. According to certain embodiments of the present invention, the child identification card 10 and the parent identification card 12 are smart cards that include a memory chip 14. In these embodiments, the biometric and/or all personal information is stored in memory on the chip 14.

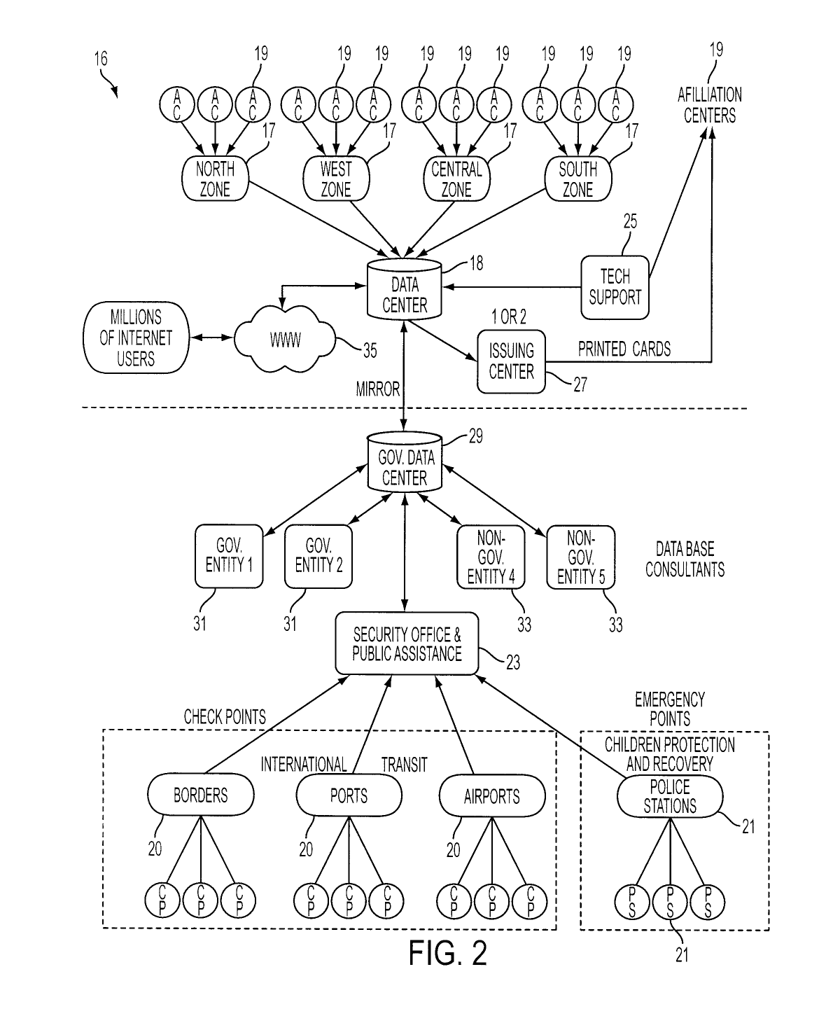

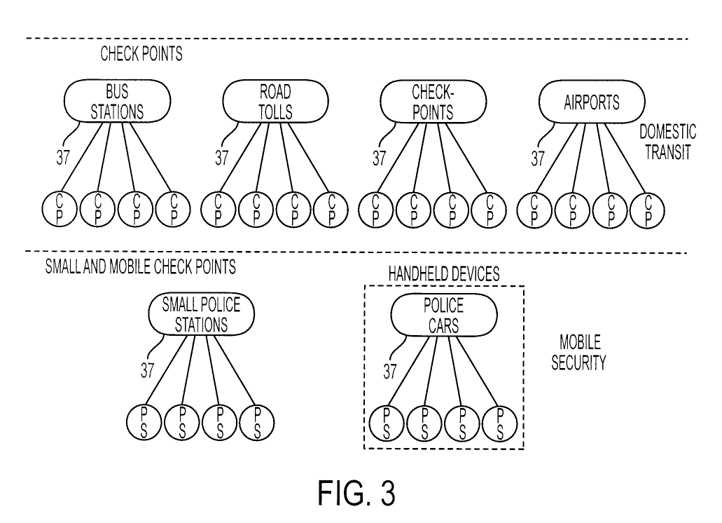

FIG. 2 illustrates a child identification system 16 according to an embodiment of the present invention for use in conjunction with the identification cards 10, 12 illustrated in FIG. 1. FIG. 3 illustrates additional components of the child identification system 16 illustrated in FIG. 2.

According to certain embodiments of the present invention, a national or international database is established and information from some or, typically, all of the child identification cards 10 and parent identification cards 12 discussed above is stored in the database. Once the database has been established, all adults traveling with children can be either requested or required to carry parent identification cards 12 that establish who their children are. In the embodiment of the present invention illustrated in FIG. 2, such a database is physically located at the central register/data center 18, which may be operated and maintained, for example, by a non-governmental entity.

As illustrated in FIG. 2, the data center 18 is connected to a plurality of affiliation centers 19 (distributed across a plurality of geographic zones 17) where parents typically go to sign up for and to pick up ID cards for themselves and their children. A tech support center 25 is located between the affiliation centers 19 and the data center 18 to deal with technical issues that may arise in the system. One or more issuing centers 27 are also located between the data center 18 and the affiliation centers 19. The issuing center 27 forwards ID cards to the affiliation centers 19.

The child identification system 16 illustrated in FIG. 2 also includes a set of checkpoints 20 (e.g., at borders, police stations, hospitals, ticket counters of commercial carriers) where the IDs of adults and children traveling together may be checked. If proper ID cards cannot be produced for all of the adults and children, further investigation may be warranted and the group of adults and children may be asked to await the results of the investigation.

Also connected to the data center 18, typically through an office of security and public assistance 23, are a plurality of emergency points 21 (e.g., police stations). At any of these emergency points 21, a parent can report an emergency (e.g., a missing child, a kidnapped child, a runaway)

The data center 18 is also connected to a governmental data center 29 (i.e., a database controlled by a regional or national government). In turn, the governmental data center 29 is connected to a plurality of governmental entities 31 and/or non-governmental entities 33 (e.g., governmental agencies that may be responsible for child welfare, worldwide non-profit organizations concerned with the wellbeing of children, etc.). In addition, as mentioned above, the governmental data center 29 is connected to the office of security and public assistance 23 which, according to certain embodiments of the present invention, controls and/or keeps track of missing children reports and/or coordinates and/or authorities the actions taken and development of each case. In turn, this office 23 is connected to the above-mentioned plurality of potential checkpoints 20 such as regional or national borders, ports, airports, police stations, etc. According to certain embodiments of the present invention, each checkpoint 20 is connected to the overall system's database 18 through the Internet 35, which system operators may use to make sure that no children are traveling with unauthorized adults.

As illustrated in FIG. 3, other locations 37 that may have access to the system through the Internet (and which may thus also act as checkpoints) include bus stations, road tolls, other checkpoints, airports, small police stations and police cars. At least in theory, providing more checkpoints makes it more difficult for a child to travel with an unauthorized adult.

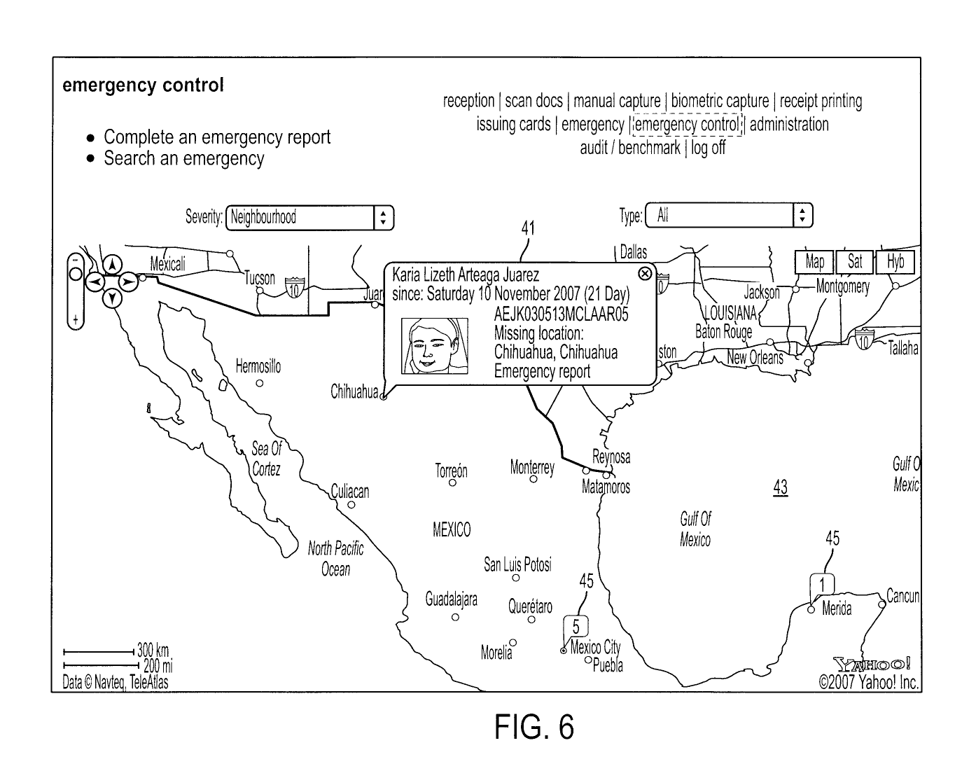

One particular advantage of allowing access to the system discussed herein through the Internet is that a world-wide solution is provided. More specifically, according to certain embodiments of the present invention, any person with Internet access (e.g., parents, children, institutions, governments) can access and take advantage of information stored in the system (e.g., missing child reports 41, particularly those shown overlain onto a map 43, as illustrated in FIG. 6, which can point out an exact location where a child went missing and which can illustrate different emergencies 45 in different colors depending on the type of emergency being experienced (e.g., red for an abduction, orange for a runaway, yellow for a lost child or unknown situation)). It should be noted, however, that private networks (i.e., networks not connected to the Internet) are also within the scope of certain embodiments of the present invention.

As mentioned above, some systems according to the present invention include at least two different sets of ID cards (i.e., child and parent ID cards 10, 12). Also, some child ID cards are designed for small children while others are designed for teenagers (i.e., some cards will carry information about schools and other types of information that would not be available for a toddler). With respect to parent ID cards, some are designed to contain information about one parent and one child and some are designed to contain information about one parent and multiple children. The latter type of parent ID cards are designed to eliminate the need for a parent of multiple children to carry a different card for each child.

According to certain embodiments of the present invention, both the child ID cards and the parent ID cards contain two different types of information. As mentioned above, one type of information (e.g., biometric information) is stored electronically in a storage device (e.g., the memory chip 14) included on the card. As illustrated in FIG. 1, the other type of information is printed on the card itself.

Although all of the information discussed herein may be stored electronically on the cards, among the type of information that may be printed on the card itself is the following: (1) personal information (e.g., name, address, gender, date of birth (DOB)); (2) certain biometric information (e.g., a photograph); (3) information about the particulars of the child (e.g., skin color, hair color, height, weight); (4) medical information (e.g., information about allergies to medicines, chronic illnesses, handicaps); (5) Academic information (e.g., school name, grade); (6) other data (e.g., Social Security number, passport number, numbers of other government-issued documents).

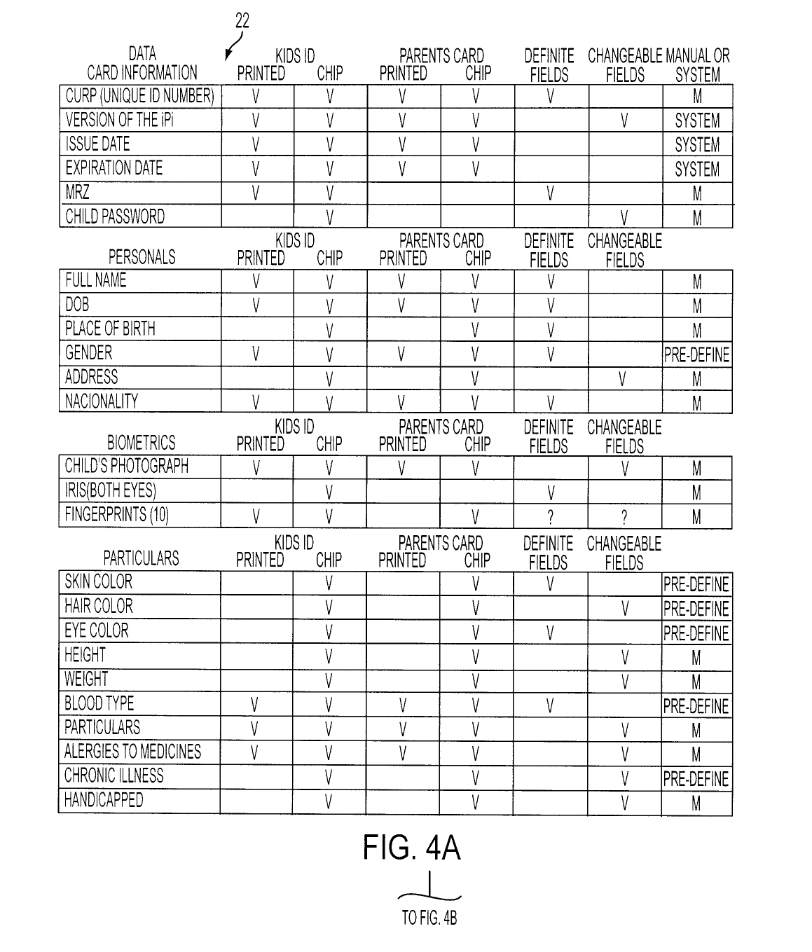

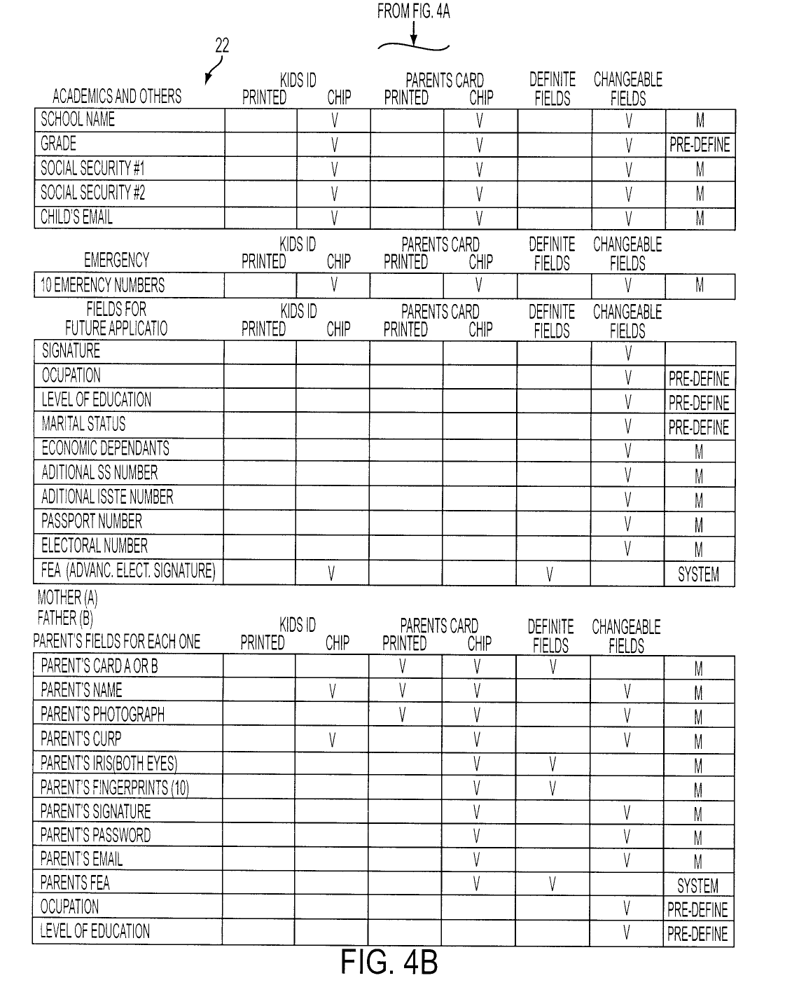

FIG. 4 includes a table 22 that lists information contained on representative ID cards according to certain embodiments of the present invention. In the left-most column of the table 22, examples of all of the types of information mentioned above are listed. In the 2^{nd} and 3^{rd} columns from the left in the table 22, check marks indicate which pieces of information are included in a representative child ID card. In the 4^{th} and 5^{th} columns from the left, check marks indicate which pieces of information are included in a representative parent ID card.

The table 22 included in FIG. 4 also shows which information is printed on a representative card, which information is stored electronically on the card and which information is both printed and stored. It should be noted that, according to other embodiments of the present invention, more information, other information or less information may be stored on the cards.

Some information stored on ID cards according to certain embodiments of the present invention will not be changeable (e.g., DOB). However, other information will be changeable (e.g., address). Some information (e.g., Social Security numbers) will be entered manually by a system operator (e.g., a government employee at an ID card distribution center). Other information will be input via a system (e.g., the version number of the card if previous cards have been lost, destroyed, damaged, etc.). According to certain embodiments of the present invention, in order to minimize operator error, some information will be pre-defined in pull-down menus for the operators inputting the information (e.g., skin color).

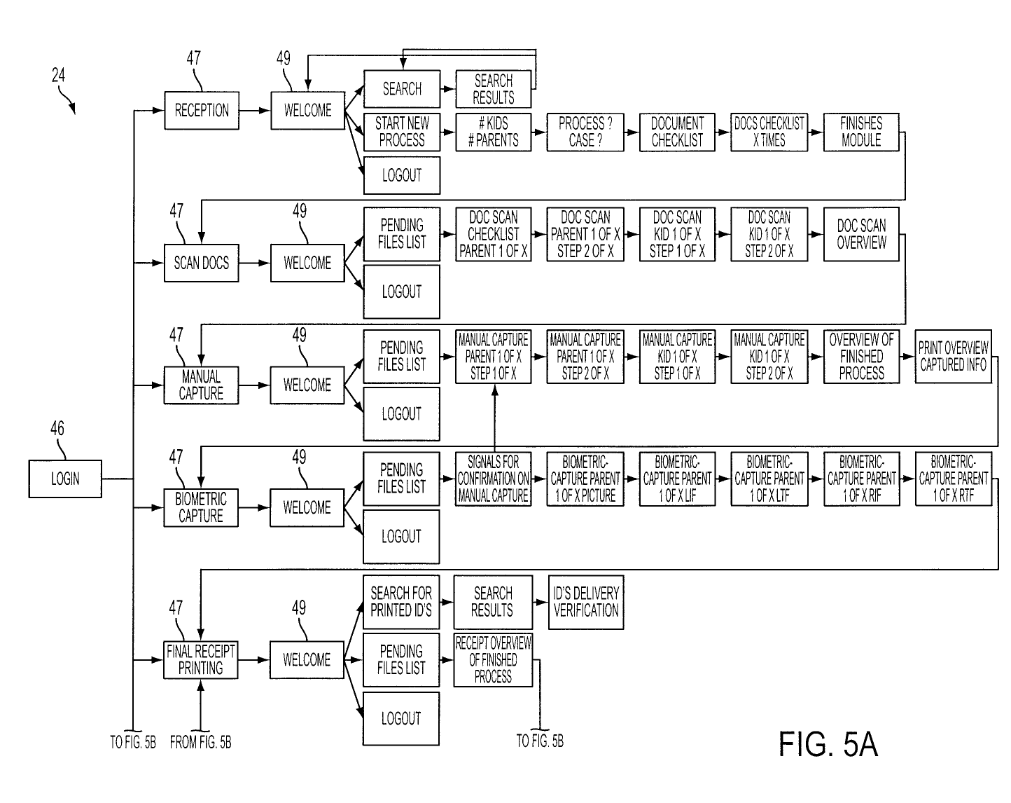

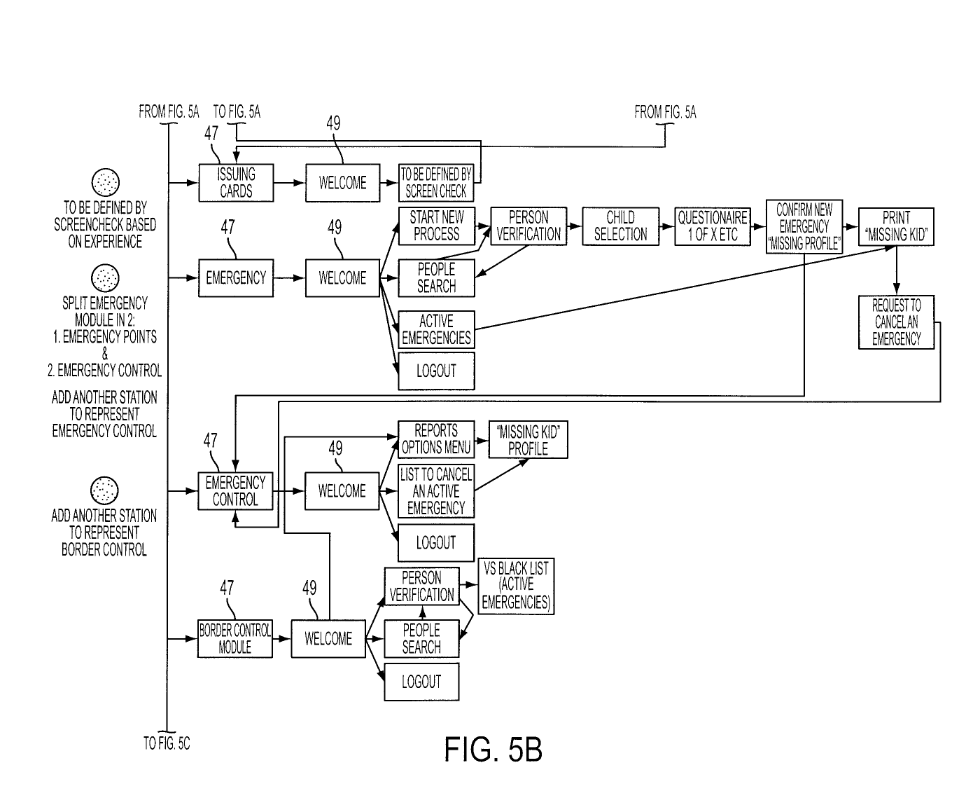

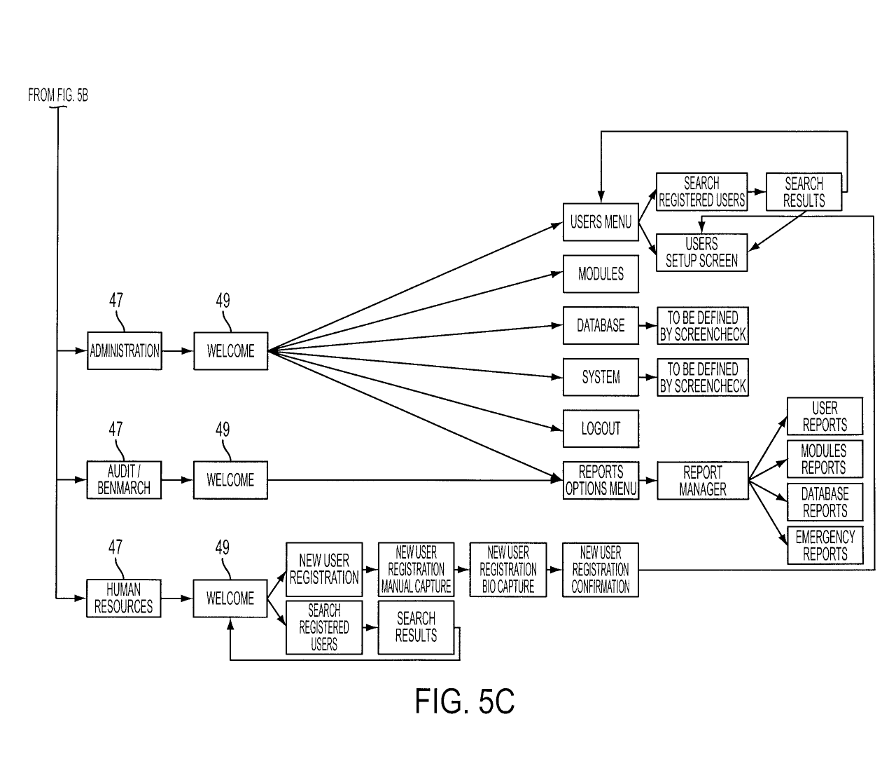

FIG. 5 illustrates a flowchart 24 of a process for entering, storing and using child and parent information according to an embodiment of the present invention and illustrates how a process progresses. The process is typically carried out using the Internet to connect to one or more of the components of the above-discussed system. Typically, one or more graphical user interfaces (GUIs) (e.g., computer monitors, touch screens, etc.) are used, in turn to connect to the Internet.

As shown in the flowchart 24, initially, a system operator (e.g., an employee of the corporate entity which distributes the above-discussed identification cards 10, 12 or a government employee) logs into the system (e.g., at step 46) via an interface (e.g., a GUI) located at one of the locations included in the system 16 illustrated in FIGS. 2 and 3. According to certain embodiments of the present invention, the logging in process is initiated when a parent approaches the operator and requests that information about a child or children and/or about the parent(s) be entered into the system. Typically, the logging in process involves the system operator typing in his or her username and password and providing a piece of his or her own biometric identification.

After successfully logging in to the system, the system operator decides which system module to employ. According to certain embodiments of the present invention, module selection is performed by selecting an appropriately labeled icon or button on the system operator's interface. As illustrated in FIG. 5, modules 47 according to the present invention include, but are not limited to, the following: Reception, Scan Docs, Manual Capture, Biometric Capture, Final Receipt Printing, Issuing Cards, Emergency, Emergency Control, Border Control, Administration, Audit/Benchmark and Human Resources. Other modules that will become apparent to one of skill in the art as useful upon practicing one or more embodiments of the present invention are also within the scope of the present invention.

When the system operator selects the Reception module, the operator is provided with a Welcome screen (e.g., at step 49). Using the Welcome screen, the operator may select either to Search sub-module to see if a child or parent in question is already in the system or may Start a New (Registration) Process. If the Search sub-module is selected, multiple types of information may be requested from the parent and used to find any existing records about the child and/or parent on the system. For example, the parent may be requested by the operator to provide names, Social Security numbers, etc.

Results of the Search function, according to certain embodiments of the present invention, are displayed on a computer screen that includes, among other information, a picture of the person (e.g., the child) searched for and the pictures of the person's relatives (e.g., the child's parents). Other relevant information about the child's relatives may also be displayed (e.g., names, addresses, phone numbers, identification numbers, etc.).

As mentioned above, instead of conducting a Search for information on the system, the Start a New Process sub-module may be selected. In such instances, the operator of the system typically inputs into the system whether the child in question is be registered to one parent, to two parents, or to an institution (e.g., an orphanage). Then, the type of new process is selected by the operator of the system from the GUI. If there is no information about the child on the system, a “Completely New” process will be initiated. Otherwise, either an “Update” process will be initiated wherein the operator will input more recent data about the child and/or parent or a “Report Stolen” process will be initiated.

When a “Completely New” process is initiated, according to certain embodiments of the present invention, the first step is for the operator to identify the circumstances of the child in question and the information that should be entered (i.e., the “case number” of the situation in question). In order to assist the operator, the GUI can be configured to provide a pull-down menu.

When the child is of a single parent (i.e., Case I on the pull-down menu), the information to be entered into the system is typically found on the child's birth certificate, which would certify that no father has been identified. Hence, the system will request that the operator input information from that document. When one of the child's parents is deceased (i.e., Case II on the pull-down menu), the information to be input is typically found on the death certificate of the deceased parent. When both of the child's parents are absent (i.e., Case III), the information to be entered into the system may be found on an approved and signed Parent's Authorization Form. When the child's parents have divorced (i.e., Case IV), the information is found in a “Confirmation Letter” (e.g., a notarized court record) of the divorce. When one or both of the child's parents suffers from a medical condition (i.e., Case V), the information is typically found in an “Official Health Certificate.” When the child has been adopted (i.e., Case VI), the information may be found in a birth certificate or adoption papers. When one or both of the child's parents are missing (i.e., Case VII), information from a “Judicial Authorization” may be entered. When one or both of a child's parent are incarcerated (i.e., Case VIII), the information may be found in a signed Parent's Authorization Form or a “Judicial Authorization”. When both parents are present (i.e., Case IX), no additional documents are required. Lastly, when neither parent is present (i.e., Case X), the information may be found in a birth certificate, adoption papers or a “Judicial Authorization.”

It should be noted that pull-down menus similar to the ones described above may be used throughout the child identification systems according to the present invention. Such menus simplify the process for system operators by automatically identifying and requesting the information to be input. Also, such menus minimize errors by preventing operators from inputting inappropriate or insufficient information.

According to certain embodiments of the present invention, once the case number has been selected from the above-discussed pull-down menu, the Scan Docs module is automatically engaged and the operator of the system is prompted to enter information from and/or to scan the relevant documents into the system. However, as shown in the flowchart 24, the Scan Docs module may also be selected immediately after the operator logs into the system.

Once the Scan Docs module is engaged, the system will request that one or more documents be scanned into the system by the operator. Examples of the documents that may be scanned into the system include, but are not limited to, birth certificates, address documents, personal identification documents (typically for parents), authorization forms, legal residency documents, court documents (e.g., custody documents), health certificates, death certificates and academic certificates.

After logging into the system, if the operator selects the Manual Capture module, information about the location where the operator is located is typically automatically entered into the system. For example, if the operator is sitting at the second counter of a registration facility where ID cards may be applied for and obtained, the number of the counter (i.e., “2”) will be typically automatically be entered into the system database. This information is stored largely for quality control purposes (e.g., to determine whether an operator makes an unusual number of errors when inputting data).

Once the counter information has been stored, the operator then manually enters relevant information about the child/children and/or the parent(s) sitting on the other side of the counter from the operator. A representative but non-exhaustive list of information that may be input is included in the table 22 included in FIG. 4.

According to certain embodiments of the present invention, up to nine emergency phone numbers may be manually entered and registered for each child using the Manual Capture module. For example, the phone number of a grandparent, a family doctor, a neighbor, etc. may be entered. However, according to other embodiments of the present invention, more or fewer than nine numbers may be registered. Also, persons authorized to travel with the child may be listed (e.g., grandparents, aunts, uncles, etc.)

When the Biometric Capture module is selected by the system operator, the system will request one or more of the following: signatures, photographs, fingerprints (of one or more fingers), iris information, etc. Each of these pieces of information may be collected from each of the parents and/or children by the operator, typically using technology available at the counter.

Once all of the desired information has been entered into the system for all of the parents and children in question, the system operator may select the Final Receipt Printing module. Using this module, a document (i.e., a receipt) may be printed out that memorializes what types of information has been provided to date. A copy of this document may be stored on the system, but a hard copy of this document is also typically delivered to the parent(s). According to certain embodiments of the present invention, each time that more information is entered into the system, a log number (i.e., a receipt number) may be assigned to the transaction and a separate receipt may be printed for the parent's records. Also, each receipt generated may include information such as whether an individual was present or absent when the information was entered and whether a transaction merely updated information or if new information was provided.

As illustrated in FIG. 2, the system 16 is connected to the World Wide Web (WWW). As such, according to certain embodiments of the present invention, a parent may access the system on-line to confirm that a particular transaction has been finalized and/or to see if one or more identification cards are ready for pick-up. More generally, systems according to the present invention may be connected to the Internet, typically through a port situated at the data center 18.

According to certain embodiments of the present invention, any identification cards generated by the system by the Issuing Card module may only be picked up by a parent or guardian. When the parent does come to pick up one or more cards, the system will ask for biometric information to be provided by the parent so that the system can compare the information provided automatically to stored information. Also, a picture may automatically appear on the operator screen to allow the system operator to instantly compare the picture to the parent's appearance and to further confirm that the person at the counter is indeed one of the parents.

Some systems according to the present invention also include an Administration module. This module typically is designed to allow a system manager to more effectively manage and/or supervise operators of the system. The specifics of this module will vary from system to system but typically allows a manager to track when and where system operators have been stationed over time. This module may also have the capability of running system and/or database diagnostics, etc.

According to certain embodiments of the present invention, the system and method described above is used in case of an emergency (e.g., the loss of a child or a child abduction). According to these embodiments, there are typically two modules that may be engaged when a parent reports a lost or abducted child: the Emergency module and the Emergency Control module.

Under the Emergency module, three options are typically presented to the operator of the system: “Start a New Process,” “Initiate a People Search,” and “Activate Emergencies.” When starting a new process, the first step typically involves verifying that the person initiating the process is indeed a parent or guardian of the missing child, or is otherwise registered in the child's records. This step is typically performed using information provided on the parent ID card that the person initiating the process preferably carries and presents to the system operator. This information on the card is compared to information stored in the system about the parent or guardian. To simplify this process, according to certain embodiments of the present invention, the parent ID card itself may be inserted into a system port and information therefrom (including biometric information) may be downloaded. Also, or as an alternative, the parent may directly have their biometric information scanned. Once the identity of the parent has been confirmed, the system operator selects which of the parent's children is missing.

Once the child in question is identified, the system according to certain embodiments of the present invention provides a questionnaire on the operator's GUI that requests details about the emergency situation. The questionnaire is typically filled out by the system operator based on answers provided by the parent. Then, a missing child report is generated by the system and can be forwarded to the appropriate authorities.

The questionnaire may, for example, include one or more of the following representative questions:

“When/where was the child last seen?”

“What was the child wearing at the time?”

“Was the child with someone at the time?”

“Have you communicated with the child since the disappearance?”

“Was the child recently injured?”

“Was the child carrying anything at the time?”

“Does the child have braces?”

“What kind of haircut did the child have?”

“Were there any witnesses to the abduction?”

“Did you see the abductor?”

“Does the child have a history of running away?”

Additional questions that would become apparent to one of ordinary skill in the art to ask upon practicing one or more embodiments of the present invention are also within the scope of the present invention. Typically, the function of the questionnaire is to provide a standardized list of questions that may be systematically asked during the emergency (i.e., when the parent and/or operator are particularly stressed).

The “Initiate a People Search” option of the Emergency module allows for accommodating a parent that approaches a system operator without a parent ID card. For example, as mentioned above, rather than presenting a card, this sub-module allows for biometric data to be used exclusively to identify the parent, guardian or person reporting the emergency.

The Active Emergencies module, when chosen, provides a list of all emergencies that the system is aware of. This list may be sorted by city, state, time period, etc. for statistical purposes. This module, according to certain embodiments of the present invention, shows a worldwide map with all emergencies that the system is aware of indicated thereon. The emergencies can also be sorted by city, state, country, time period, type (e.g., abduction, runaway, lost), severity (e.g., neighborhood, city, national, international). In addition, the system allows users to select any emergency shown on the map and to see the associated emergency report.

Once the child is found, a request may be entered by a system operator to cancel the emergency. However, as will be discussed below, this Request to Cancel an Emergency option is typically selected from the Emergency Control module.

The Emergency Control module provides similar features to the Emergency module. However, because the Emergency Control module is typically directly connected to the authorities (e.g., to the local police or border patrol stations via the Internet, phone lines, etc.) the reports generated are different. For example, the Emergency Control module can provide a Missing Child Profile. Also, the Emergency Control module, according to certain embodiments of the present invention, is the module that provides a list of all emergency cancellations that are awaiting confirmation. Typically, although an emergency may be initiated by an operator of the system, an emergency can only be cancelled by an operator of the Emergency Control module. This assures that all cancellations can be certified at a single location.

The Border Control module of the above-discussed system 16 is typically available to system operators at national and/or state borders and/or at airports, train stations, bus stations, ports, etc. This module typically asks the operator to request parent and child identification cards in order to certify that the children are accompanied by authorized adults. However, if cards are not available, biometric information may be used instead. Also, this module may include a list of active emergencies, typically at least for the region where the module operator is located.

In view of the above, it should be apparent that not all system operators may have identical duties or access to the system. For example, some operators collect information from the parents and children when the entire family is together. Other operators may exclusively interact with parents during times of crisis. Yet other operators may only interact with the parents and/or children when the family is traveling across a border. Still other operators may exclusively perform administrative duties that keep the system operating optimally.

Like the above-mentioned Administration module, the Audit/Benchmark and Human Resources modules may be configured in any way that the administrator(s) of the above-discussed system 16 will find most pertinent to their individual needs. For example, these modules may be used to keep track of where various system operators are working, how many hours each system operator has worked over a given time period, how many typographical and/or scanning errors have been made at a particular location and/or over a chosen amount of time, etc. Typically, reports from these modules are generated primarily for the use of system administrators and are never seen by parent or children whose information is stored in the system.

In conclusion, it should be appreciated that certain embodiments of the present invention allow for all of the members of a family to easily and cost-effectively obtain identification cards that include a wealth of information. Certain embodiments of the present invention also provides a system with which these cards may be used. According to certain methods of operating the system within the scope of the present invention, the identification cards can be checked at regional and/or national borders and/or at other checkpoints, thereby making it more difficult for a child to be traveling with an unauthorized adult.

The many features and advantages of the invention are apparent from the detailed specification, and thus, it is intended by the appended claims to cover all such features and advantages of the invention which fall within the true spirit and scope of the invention. Further, since numerous modifications and variations will readily occur to those skilled in the art, it is not desired to limit the invention to the exact construction and operation illustrated and described, and accordingly, all suitable modifications and equivalents may be resorted to, falling within the scope of the invention.

What is claimed is:

1. A set of identification cards, comprising:
a first child identification card that includes personal information about a first child and a parent of the first child; and
a parent identification card that includes personal information about the parent and the first child.

2. The set of identification cards recited in claim 1, wherein at least one of the first child identification card and the parent identification card includes the personal information in a plainly visible format.

3. The set of identification cards recited in claim 1, wherein at least one of the first child identification card and the parent identification card includes the personal information in an electronic format.

4. The set of identification cards recited in claim 1, wherein at least one of the first child identification card and the parent identification card includes biometric information.

5. The set of identification cards recited in claim 1, further comprising:
a second child identification card that includes personal information about a second child and the parent, wherein the parent is related to the first child and the second child.

6. The set of identification cards recited in claim 1, further comprising:
a second parent identification card that includes personal information about a second child and a second parent, wherein the second parent is related to the first child.

7. The set of identification cards recited in claim 5, wherein the parent identification card further includes personal information about the parent and the second child.

8. A child identification system, comprising:
a first module where information is submitted to generate a child identification card that includes personal information about a child and a parent of the child and a parent identification card that includes personal information about the parent and the child;
a second module wherein the information submitted is stored; and
a third module wherein the child identification card and the parent identification card may be compared to confirm that an adult accompanying the child is the parent and is authorized to travel with the child.

9. The child identification system recited in claim 8, further comprising:
a fourth module where the parent can report an emergency situation.

10. The child identification system recited in claim 8, further comprising:
a government database operably connected to the second module and configured to access the information submitted.

11. The child identification system recited in claim 8, wherein the second module includes an Internet port connection.

12. The child identification system recited in claim 8, wherein the third module is located in one of a regional border, a national border, an airport, a train station, a bus station, a port and a law enforcement facility.

13. The child identification system recited in claim 8, further comprising:
an issuing center operably connected to the second module and from which at least one of the child identification card and the parent identification card is forwarded to the first module.

14. A child identification procedure, comprising:
obtaining information about a parent and a child;
generating a child identification card that includes personal information about the child and the parent of the child; and
generating a parent identification card that includes personal information about the parent and the child.

15. The child identification procedure recited in claim 14, wherein the obtaining information step comprises scanning documents into a central database.

16. The child identification procedure recited in claim 14, wherein the obtaining information step comprises utilizing pre-defined menus to manually enter the information into a central database.

17. The child identification procedure recited in claim 14, wherein the obtaining information step comprises obtaining at least some of the information as biometric information.

18. The child identification procedure recited in claim 14, further comprising:
storing at least some of the information on at least one of the child identification card and the parent identification card in an electronic format.

19. The child identification procedure recited in claim 14, further comprising:
providing a checkpoint wherein the child identification card and the parent identification card are compared to each other to ascertain whether an adult traveling with the child is authorized to do so.

20. The child identification procedure recited in claim 14, further comprising:
making the information available to at least one of a regional government entity, a national government entity and a non-governmental organization.

21. The child identification procedure recited in claim 14, further comprising:
generating a report utilizing the information when the child is declared missing; and
forwarding the report to a law enforcement agency.

22. The child identification procedure recited in claim 21, further comprising:
actively displaying emergencies on a map;
categorizing the emergencies by color and number; and
allowing a user to view a particular emergency by selecting the particular emergency on the map.

23. The child identification procedure recited in claim 14, further comprising:
generating a receipt for the information obtained; and
providing the receipt to the parent.
